(19) United States
(12) Patent Application Publication
(10) Pub. No.: US 2004/0223890 A1
(43) Pub. Date: Nov. 11, 2004

(54) Clamshell slide holder

(76) Inventors: Douglas G. Summers, Sunnyvale, CA (US); George P. Tsai, San Jose, CA (US)

Correspondence Address: AGILENT TECHNOLOGY, INC., Legal Department, DL429, Intellectual Property Administration, P.O. Box 7599, Loveland, CO, 80537-0599, US

(21) Appl. No.: 10/434,866

(22) Filed: May 9, 2003

(51) Int. Cl. B01L 9/00

(52) U.S. Cl. 422/104; 436/174

(57) ABSTRACT

A clam shell slide holder for mounting and retaining a slide. The clamshell slide holder includes a single contiguous base and a lid attached to the base. The base of the clamshell slide holder includes a first slide holder, second slide holder adjacent to the first slide holder, a third slide holder, and a fourth slide holder adjacent to the third slide holder. The lid includes at least one spring finger for contacting the slide. Also disclosed is a method of reading and mounting a slide in a clamshell slide holder.

### FIELD OF THE INVENTION

This invention relates to slides holding multiple moieties to be read, and in particular to arrays such as polynucleotide arrays (for example, DNA arrays), which are useful in diagnostic, screening, gene expression analysis, and other applications.

### BACKGROUND OF THE INVENTION

Polynucleotide arrays (such as DNA or RNA arrays) are known and are used, for example, as diagnostic or screening tools. Such arrays include regions of usually different sequence polynucleotides arranged in a predetermined configuration on a substrate. These regions (sometimes referenced as “features”) are positioned at respective locations (“addresses”) on the substrate. In use, the arrays, when exposed to a sample, will exhibit an observed binding or hybridization pattern. This binding pattern can be detected upon interrogating the array. For example, all polynucleotide targets (for example, DNA) in the sample can be labeled with a suitable label (such as a fluorescent dye), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample.

Polynucleotide arrays have previously been provided in two formats. In one format, the array is provided as part of a package in which the array itself is disposed on a first side of a glass or other transparent substrate. This substrate is fixed (such as by adhesive) to a housing with the array facing the interior of a chamber formed between the substrate and housing. An inlet and outlet may be provided to introduce and remove sample and wash liquids to and from the chamber during use of the array. The entire package may then be inserted into a laser scanner, and the sample exposed array may be read through a second side of the substrate.

In another format, the array is present on an unmounted glass or other transparent slide substrate. This array is then exposed to a sample optionally using a temporary housing to form a chamber with the array substrate. The slide is the placed in a slide holder and inserted into a scanner. In some cases the slide is directly inserted into the scanner. However, present slide holders suffer from a number of problems. In addition, poorly cut pieces of glass used for the slides are not readily accepted by the slide holder. These slides often have protrusions that produce plastic shavings as the glass slide is inserted and mounted in the slide holder. These plastic shavings can interfere with array reading and the slide holders significantly wear over time. Also, many of the slide holder designs do not properly grip the slides and allow them to fall out of the holders. Furthermore, most array holders require a number of manufacturing parts and are difficult to assemble. Lastly, other slide holders have no way of correctly aligning the slide once it is placed in a holder and mounted incorrectly. For these reasons it would be desirable to provide a slide holder that is easy to manufacture, can holder a variety of glass slide sizes, is easy to mount and does not produce plastic shavings that interfere with array readings and which can quickly and accurately align and secure a slide. These and other problems experienced by existing devices are obviated by the present invention.

### SUMMARY OF THE INVENTION

The present invention provides a clamshell holder including a contiguous base and a lid attached to the base. The base includes a single contiguous material and the lid includes one or more spring finger for securing the slide in the clamshell slide holder.

The present invention also provides in one aspect, a method of processing and reading an array of moieties on at least a portion of a surface of a transparent slide which has been previously exposed to a sample. The method allows the transfer of the array between multiple processing containers and includes mounting the slide on a clamshell slide holder and retaining the slide thereon without the array contacting the clamshell slide holder. The clamshell slide holder is then inserted into an array reader and the array read.

### BRIEF DESCRIPTION OF THE DRAWINGS

Embodiments of the invention will now be described with reference to the drawings, in which:

FIG. 1 illustrates a slide carrying an array, of the present invention, and such as may be used in a holder and methods of the present invention;

FIG. 2 is an enlarged view of a portion of FIG. 1 showing ideal spots or features;

FIG. 3 is an enlarged illustration of a portion of the substrate in FIG. 2;

FIG. 4A illustrates a perspective view of a slider holder of the present invention;

FIG. 4B illustrates an enlarged portion of FIG. 4A.

FIG. 5 a front view of a slide holder of the present invention with open lid;

FIG. 6 is a back view of a slider holder of the present invention with closed lid;

FIG. 7A is a right side elevation of a slide holder of the present invention with open lid;

FIG. 7B is a right side elevation of a slide holder of the present invention with closed lid;

FIG. 8A is a left side elevation of a slide holder of the present invention with open lid;

FIG. 8B is a left side elevation of a slide holder of the present invention with closed lid;

FIG. 9A is a leading end elevation of a slide holder of the present invention with open lid;

FIG. 9B is a leading end elevation of a slide holder of the present invention with closed lid;

FIG. 10A is a rear view elevation of a slide holder of the present invention with open lid;

FIG. 10B is a rear view elevation of a slide holder of the present invention with closed lid;

FIG. 11 illustrates a perspective view of a slide holder of the present invention with slide insertion into the slide holder.

FIG. 12A shows a front view of the slide holder of the present invention before the lid is slid into the locking position with the mounted slide.

FIG. 12B shows a front view of the slider holder of the present invention after the lid has been slid into the locking position with the mounted slide.

FIG. 13 illustrates a method for reading and scanning of a slide holder of the present invention.

To facilitate understanding, identical reference numerals have been used, where practical, to designate identical elements that are common to the figures.

### DETAILED DESCRIPTION OF EMBODIMENTS OF THE INVENTION

In the present application, unless a contrary intention appears, the following terms refer to the indicated characteristics. A “biopolymer” is a polymer of one or more types of repeating units. Biopolymers are typically found in biological systems (although they may be made synthetically) and particularly include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucteotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups). A “peptide” is used to refer to an amino acid multimer of any length (for example, more than 10, 10 to 100, or more amino acid units). A biomonomer fluid or biopolymer fluid reference a liquid containing either a biomonomer or biopolymer, respectively (typically in solution).

An “array”, unless a contrary intention appears, includes any one, two or three dimensional arrangement of addressable regions bearing a particular chemical moiety or moieties (for example, biopolymers such as polynucleotide sequences) associated with that region. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probes” may be the one that is to be evaluated by the other (thus, either one could be an unknown mixture of polynucleotides to be evaluated by binding with the other). An “array layout” refers collectively to one or more characteristics of the features, such as feature positioning, one or more feature dimensions, and some indication of a moiety at a given location. “Hybridizing” and “binding”, with respect to polynucleotides, are used interchangeably. When one item is indicated as being “remote” from another, this is referenced that the two items are at least in different buildings, and may be at least one mile, ten miles, or at least one hundred miles apart.

It will also be appreciated that throughout the present application, that words such as “front”, “rear”, “back”, “leading”, “trailing”, “top”, “upper”, and “lower”, are all used in a relative sense only. Furthermore, when one thing is “slid” or “moved” or the like, with respect to another, this implies relative motion only such that either thing or both might actually be moved in relation to the other. All patents and other cited references are incorporated into this application by reference.

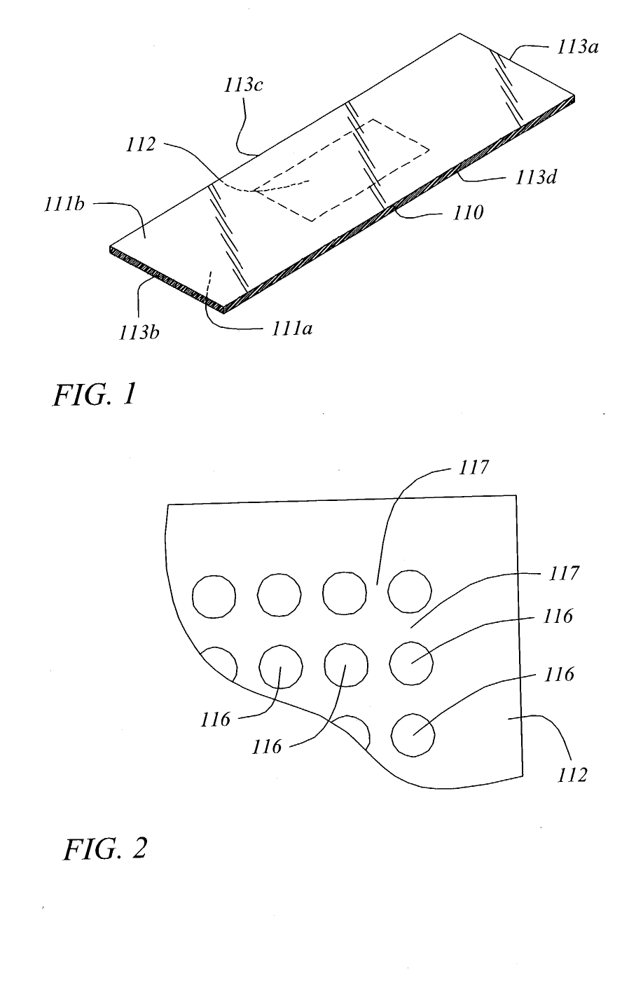

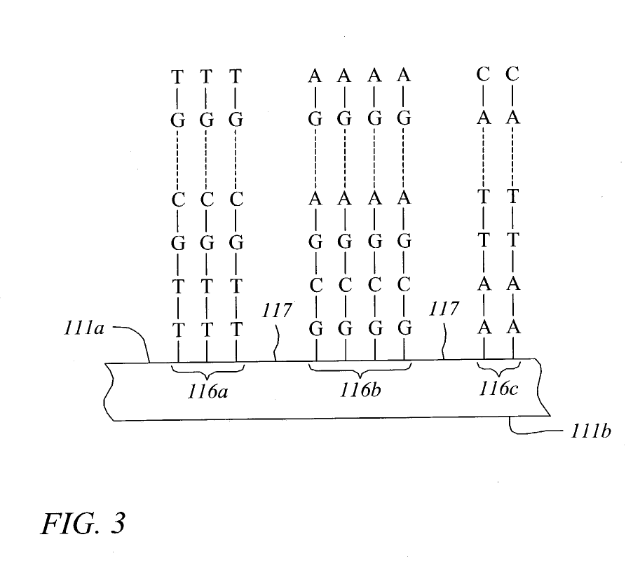

Referring first to FIGS. 1-3, typically methods and apparatus of the present invention generate or use a contiguous planar transparent slide 110 carrying an array 112 disposed on a rear surface 111b of substrate 110. It will be appreciated though, that more than one array (any of which are the same or different) may be present on rear surface 111b, with or without spacing between such arrays. Note that one or more arrays 112 together will cover the entire rear surface 111b, with regions of the rear surface 111b adjacent to the opposed sides 113c, 113d and leading end 113a and trailing end 113b of slide 110. A front surface 111a of the slide 110 does not carry any arrays 112. Each array 112 can be designed for testing against any type of sample, whether a trial sample, reference sample, a combination of them, or a known mixture of polynucleotides (in which latter case the arrays may be composed of features carrying unknown sequences to be evaluated). Slide 110 may be of any shape, and any holder used with it adapted accordingly, although slide 110 will typically be rectangular in practice. Array 112 contains multiple spots or features 116 of biopolymers in the form of polynucleotides. A typical array may contain from more than ten, more than one hundred, more than one thousand or ten thousand features, or even more than from one hundred thousand features. All of the features 116 may be different, or some or all could be the same. In the case where array 112 is formed by the conventional in situ or deposition of previously obtained moieties, as described above, by depositing for each feature at least one droplet of reagent such as by using a pulse jet such as an inkjet type head, interfeature areas 117 will typically be present which do not carry any polynucleotide. It will be appreciated though, that the interfeature areas 117 could be of various sizes and configurations. Each feature carries a predetermined polynucleotide (which includes the possibility of mixtures of polynucleotides). As per usual, A, C, G, T represent the usual nucleotides. It will be understood that there may be a linker molecule (not shown) of any known types between the rear surface 111b and the first nucleotide. However, as mentioned above, the array 112 may optionally be on the front surface 111a.

Slide 110 also carries on front surface 111a, an identification code in the form of bar code 115 printed on an opaque substrate in the form of a paper label attached by adhesive to front side 111a. By “opaque” in this context is referenced that the means used to read bar code 115 (typically a laser beam) cannot read code 115 through the label without reading errors. Typically this means that less than 60% of the signal from the code passes through the substrate. Bar code 115 contains an identification of array 112 and either contains or is associated with, array layout or layout error information in a manner such as described in U.S. patent application Ser. No. 09/302,898 (filed Apr. 30, 1999) and Ser. No. 09/359,536 (filed Jul. 22, 1999; now issued as U.S. Pat. No. 6,180,351, Jan. 30, 2001) both originally assigned to Hewlett-Packard, incorporated herein by reference.

For the purposes of the discussions below, it will be assumed (unless the contrary is indicated) that the array 112 is a polynucleotide array formed by the deposition of previously obtained polynucleotides using pulse jet deposition units. However, it will be appreciated that an array of other polymers or chemical moieties generally, whether formed by multiple cycle in situ methods adding one or more monomers per cycle, or deposition of previously obtained moieties, or by other methods, may be present instead.

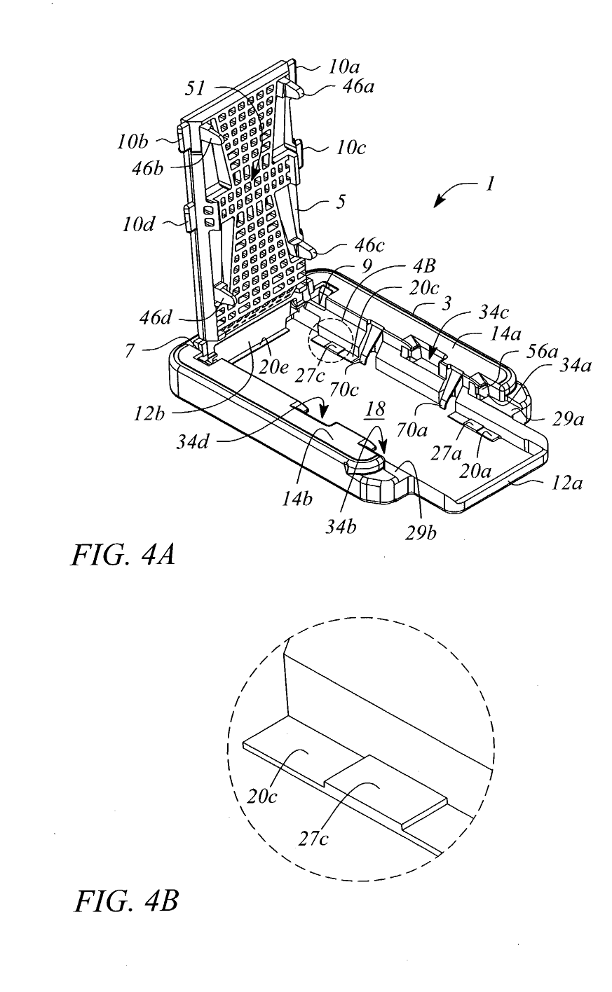

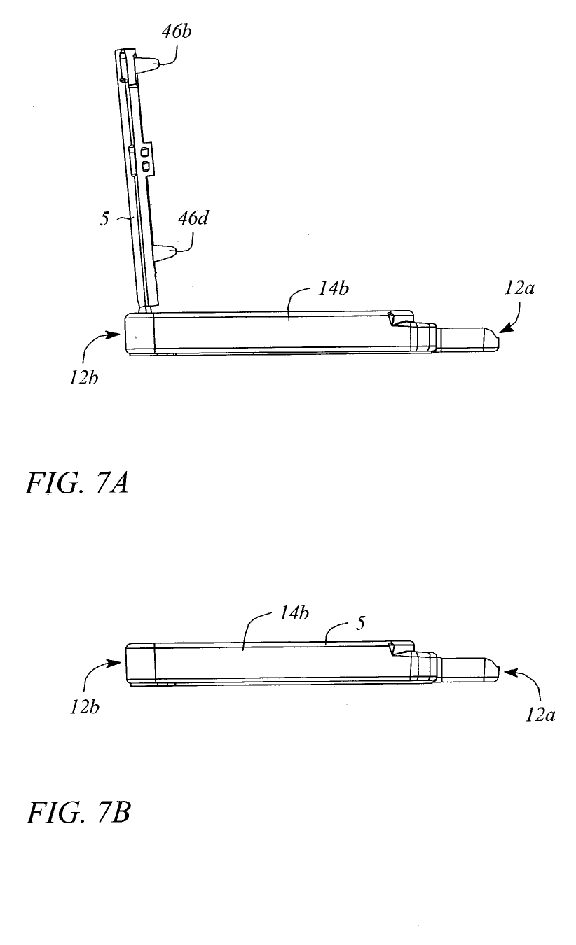

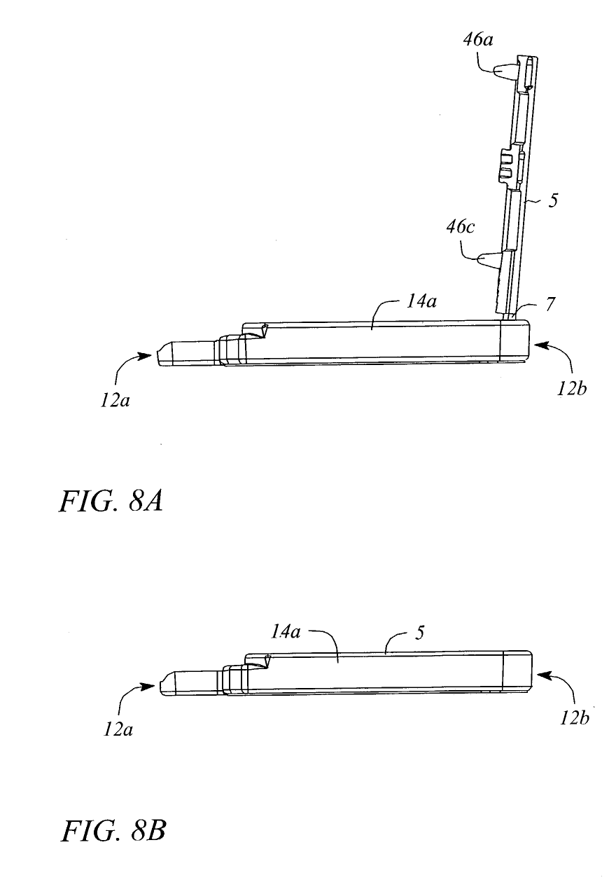

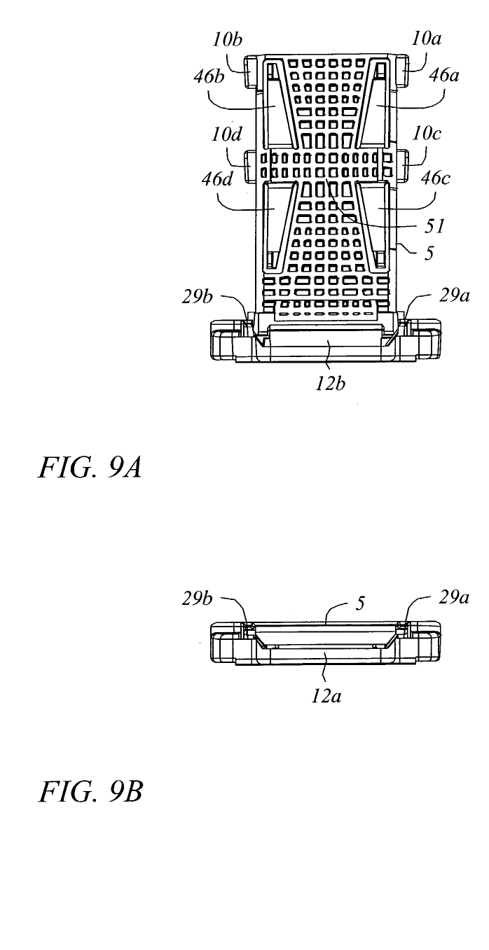

Turning now to FIG. 4-10, a clamshell slide holder 1 of the present invention will now be described in more detail. Clamshell slide holder 1 comprises a contiguous base 3 and a lid 5 attached to the base 3. The lid 5 may be attached to the base 3 using a hinge 7 and hinge joint 9.

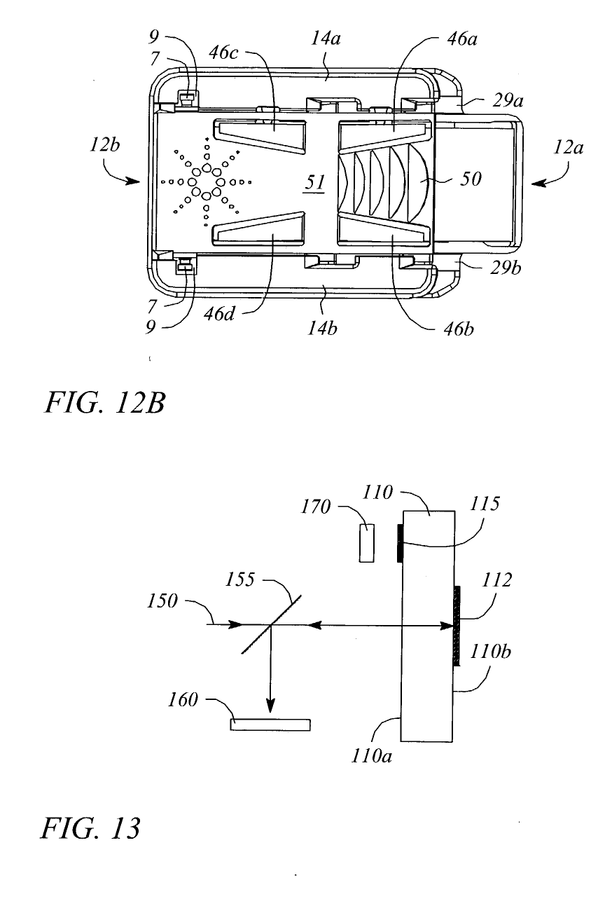

The lid 5 may comprise one or more optional tabs joined by a bridge point 51. For instance, the lid may comprise a first tab 10a, a second tab 10b, a third tab 10c and a fourth tab 10d. An optional finger contact tab 50 may also be employed on the lid 5 (See FIG. 12A). The finger contact tab 50 is used for closing and securing the lid 5 on the base 3.

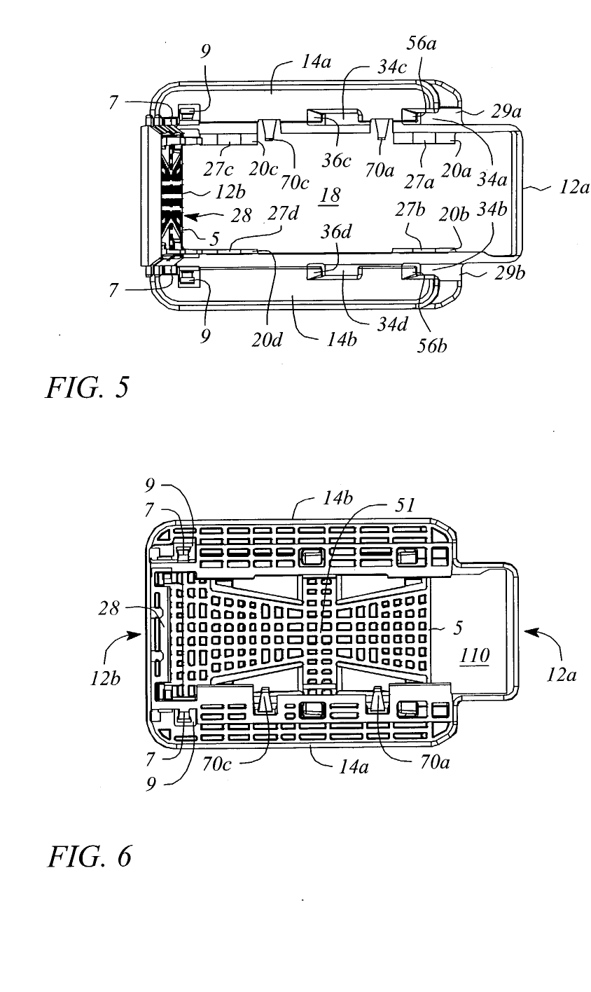

The base 3, may be rectangular in shape and comprise two opposed side portions 14a and 14b with a channel 18 positioned therebetween, and extending in a direction between ends 12a, 12b of the body. The base 3 also comprises a first slide support 20a, second slide support 20b adjacent to the first slide support 20a, a third slide support 20c, a fourth slide support 20d adjacent to the third slide support 20c and a fifth slide support 20e adjacent to the second slide support 20b and the third slide support 20c (See FIG. 5). Each of the slides supports is designed for receiving the slide 110 and has one raised reference surfaces 27a, 27b, 27c, and 27d. The raised reference surfaces 27a, 27b, 27c, and 27d raise the slide 110 above the slide supports and position the slide 110 at the bottom of the channel 18. Channel 18 lacks a bottom surface to act as a backer member, and has a closed leading end 12a and a closed trailing end 12b. The channel 18, closed leading end 12a and closed trailing end 12b are designed for receiving and enclosing the slide 110 and array 112 within the clamshell slide holder 1. The base 3 may also comprise a series of slots for receiving the tabs on the lid 5. For instance, the base 3 may optionally comprise a first slot 34a, a second slot 34b, a third slot 34c, and a fourth slot 34d (See FIG. 4 and FIG. 5). Each of the respective slots is designed for receiving a respective tab when the lid 5 is closed or is contacted to the base 3. For instance, the first slot 34a receives the first tab 10a of the lid 5. The second slot 34b is design for and receives the second tab 10b of the lid 5. The third slot 34c is designed for and receives the third tab 10c of the lid 5. The fourth slot 34d is designed for and receives the fourth tab 10d of the lid 5. The base 3 may also comprise one or more optional contact surfaces. For instance, base 3 may optionally comprise a first contact surface 29a for lid 5. In addition, base 3 may comprise a second contact surface 29b for lid 5. The first contact surface 29a and second contact surface 29b may act as guiding surfaces for sliding the lid 5 into a closed position (See FIGS. 12A and 12B).

A feature of the subject devices is that the clamshell slide holder 1 allows the user to insert and mount a slide within the clamshell slider holder 1 without producing plastic shavings or filings. Plastic shavings or filings are generally produced in slide holders that maintain a slot or track for loading the slide into position. When the slide is slid into loading position, the sliding produces small plastic shavings or filings. The plastic filings or shavings cause problem with array readings. The clamshell slide holder 1 receives and secures the slide within a single contiguous base 3 without the need for additional parts or components.

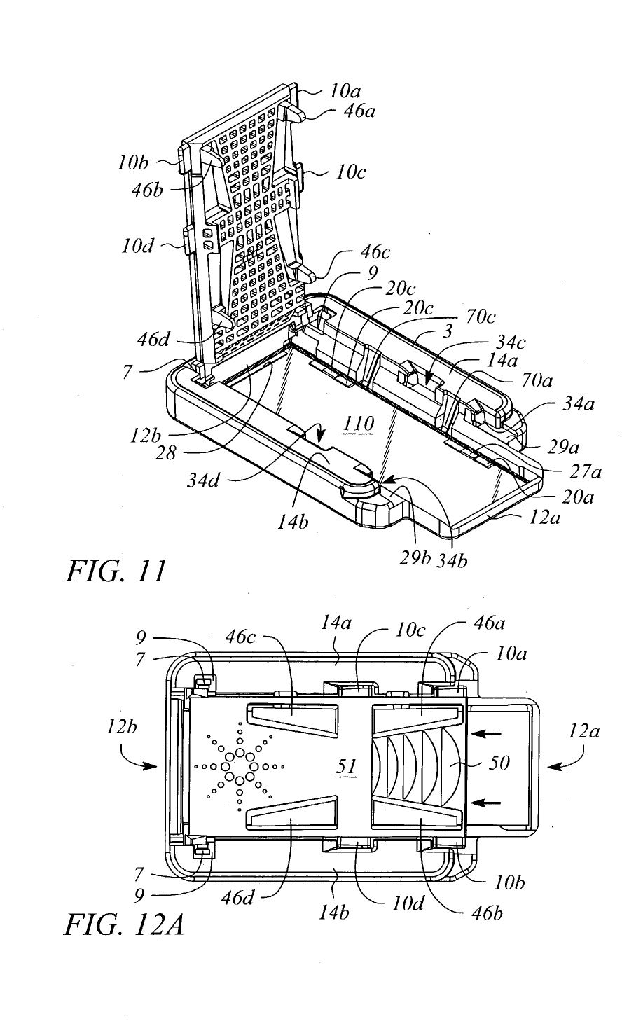

The clamshell slide holder as described, is used to mount slide 110 in a manner as will now be described. First, the array 112 will have typically been previously exposed to a fluid sample that is to be tested for moieties (such as polynucleotides) that may bind (for example, hybridize) to the moieties (such as polynucleotides) at one or more features. The moieties to be tested may be labeled with fluorescent dyes in a known manner. The array 112 may then be washed and dried in preparation for reading. At this point a user will typically grip opposing portions of the front and rear surfaces of slide 110 toward the trailing end 113b using their thumb and forefinger (See FIGS. 11-12) and insert the slide 110 into the channel 18 of the base 3. Leading edge 113a of slide 110 can then be positioned on the raised references surfaces 27a, 27b, 27c, 27d on the first slide support 20a, second slide support 20b, third slide support 20c, fourth slide support 20d and fifth slide support 20e. The fifth slide support 20e both supports the slide 110 and may act as an initial guide for inserting and contacting the leading edge 113a of the slide 110 in the channel 18 of the base 3. The raised reference surfaces 27a, 27b, 27c, and 27d, are from 1.0 millimeter (mm) to 3.0 mm in width. In certain embodiments the raised reference surfaces will be approximately 2.5 mm in width. The raised reference surfaces 27a, 27b, 27c and 27d generally maintain the slide 110 in a raised position. The slide 110 does not need to be slid into position since it is already aligned and mounted. The slide 110 sits squarely on each of the raised reference surfaces 27a, 27b, 27c, and 27d in the channel 18.

Referring now to FIGS. 11-12, after the slide 110 is mounted and aligned, the lid 5 is closed. The lid 5 is closed by rotating the lid 5 toward the front face of the base 3. The lid 5 is mounted on the base 3 using the hinge 7 that is positioned in the hinge joint 9 of the base 3. Generally, the lid 5 may be rotatably mounted using the hinge 7 in the hinge joint 9 of the base 3. The lid 5 may also be mounted for horizontal movement using the hinge 7 and hinge joint 9.

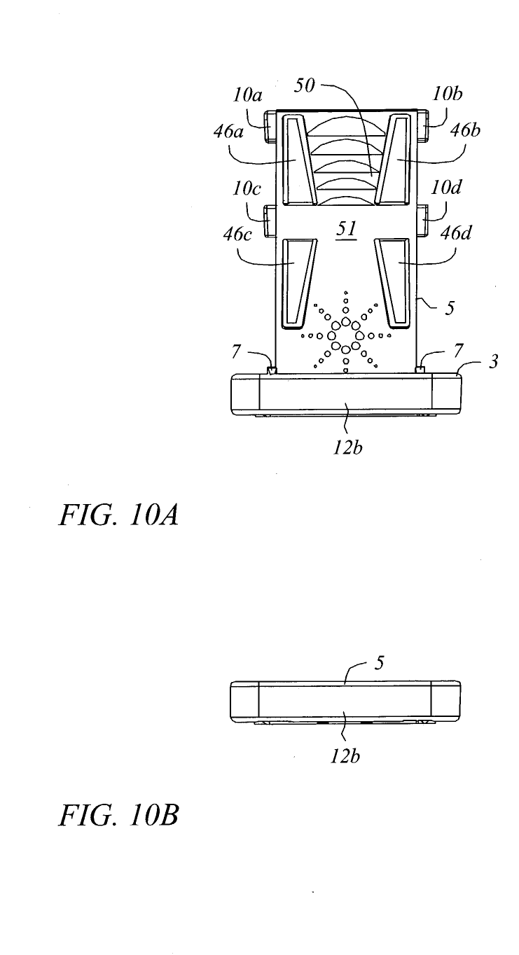

The first spring finger 46a, second spring finger 46b, third spring finger 46c and fourth spring finger 46d each engage the top surface of the slide 110. The array 112 generally faces toward the lid 5 and the spring fingers. The first spring finger 46a, the second spring finger 46b, the third spring finger 46c and the fourth spring finger 46d each engage the top surface of the slide 10 directly above the raised reference surfaces 27 on each of the respective slide supports. By positioning the spring fingers directly above the reference surfaces, bowing or bending of the glass is minimized. In other words, each of the spring fingers engages the slide 110 that is sandwiched between each spring finger and the associated slide supports (not shown in drawings). As previously discussed, the spring fingers comprise a portion of the lid 5 and are designed for spring movement as tension is then applied on the finger contact tab 50 (See FIG. 10A and FIG. 12A). At the same time, first tab 10a, second tab 10b, third tab 10c and fourth tab 10d on the lid 5, each engage their respective corresponding slots 34a, 34b, 34c and 34d. Each of the slots is designed with an engagement notch for fixing the lid 5 in position. For instance, first slot 34a has a first engagement notch 56a, second slot 34b has a second engagement notch 56b, third slot 34c has a third engagement notch 56c and fourth slot 34d has a fourth engagement notch 56d. Once each of the respective tabs is positioned within the respective slots, the entire lid 5 may be pressed downward using finger contact tab 50. This allows the entire lid 5 to be slid back horizontally so that each of the respective tabs engages their respective engagement notches (See FIGS. 12A and 12B). Once each of the tabs and lid 5 are slid horizontally toward the end 12b, the lid 5 tightly grips the slide 110 so that it will not move at all. In order to open the clamshell slide holder 1, the user must simply apply downward pressure to the finger contact tab 50 and slide the entire lid 5 forward toward the end 12a. Each of the respective tabs then will disengage their respective engagement notches and the lid 5 will be free to open. It should be noted that a second optional set of small spring fingers may be employed in one or both side portions 14. For instance, optional small spring finger 70a and small spring finger 70c may be employed in side portion 14a or 14b to further guide and support slide 110 into position when the lid 5 is closed and slid into position.

The array 112 of the enclosed slide is spaced apart from lid 5. This allows the clamshell slide holder 1 to protect the slide, while spacing the slide 110 away from each of the supports 20a, 20b, 20c, 20d and 20e. This reduces the detection of any fluorescence that might occur from response to an interrogating light.

The clamshell slide holder 1 with the enclosed and protected slide may then be inserted into a reader, such as a laser scanner, which has a suitable mounting means for receiving and releasably retaining the holder in a known position. The scanner should be able to read the location and intensity of fluorescence at each feature of an array following exposure to a fluorescently labeled sample (such as a polynucleotide containing sample). For example, such a scanner may be similar to the GENEARRAY scanner available from Agilent Technologies, Inc., Palo Alto, Calif. The array 12 may then be read through front side 110a of slide 110 in a manner illustrated in FIG. 13. In particular, a scanning interrogating laser beam 150 is directed through a beam splitter 155 and then through front side 110a and scanned across array 12. Resulting fluorescent signals from the array that have passed back through slide 110 and out through front side 110a may then be detected at detector 160. Results from the interrogation can be processed such as by rejecting a reading for a feature which is below a predetermined threshold and/or forming conclusions based on the pattern read from the array (such as whether or not a particular target sequence may have been present in the sample). The results of the interrogation or processing can be forwarded (such as by communication) to a remote location if desired, for further use. The bar code 115 is read from the front side of slide 110 by bar code reader 170. Information from the read bar code 115 can be used to retrieve array layout information which can be used in the reading and/or processing of the interrogation results, in a manner as described in U.S. patent application Ser. No. 09/302,898 (filed Apr. 30, 1999) and Ser. No. 09/359,536 (filed Jul. 22, 1999; now issued as U.S. Pat. No. 6,180,351, Jan. 30, 2001) both originally assigned to Hewlett-Packard, incorporated herein by reference.

The clamshell slide holder 1 is made in one molded section from an opaque plastic, such as black ABS plastic (although other materials could be used). The color of clamshell slide holder 1 is preferably black to minimize any fluorescent noise or signal contribution from the clamshell slide holder 1. Also, the clamshell slide holder 1 being opaque prevents any interrogating light from being scattered around inside the scanner

Various further modifications to the particular embodiments described above are, of course, possible. Accordingly, the present invention is not limited to the particular embodiments described in detail above.

We claim:

1. A clamshell slide holder for holding a slide, comprising:
(a) a single contiguous base for mounting and holding the slide; and
(b) a lid mounted on the base for closing the clamshell slide holder and securing the slide in a fixed position.

2. A clamshell slide holder as recite in claim 1, wherein the base further comprises at least one slide support for mounting the slide.

3. A clamshell slide holder as recited in claim 1, wherein the base further comprises a first slide support, a second slide support adjacent to the first slide support, a third slide support, and a fourth slide support adjacent to the third slide support, each slide support designed for receiving and supporting a slide positioned in the base without causing bowing of the slide.

4. A clamshell slide holder as recited in claim 1, wherein the lid further comprises at least one spring finger for securing a slide.

5. A clamshell slide holder as recited in claim 1, wherein the lid further comprises a first spring finger, a second spring finger adjacent to the first spring finger, a third spring finder and a fourth spring finger adjacent to the third spring finger for securing a slide.

6. A clamshell slide holder as recited in claim 3, wherein the slide supports are positioned such that they can receive and retain a slide having an area of no more than 200 cm².

7. A clamshell slide holder as recited in claim 3, wherein at least one slide support further comprises one raised reference surface.

8. A clamshell slide holder as recited in claim 7, wherein the raised reference surface is from 1.0 to 3.0 millimeters in width.

9. A clamshell slider holder as recited in claim 7, wherein the raised reference surface is 2.5 millimeters in width.

10. A clamshell slide holder as recited in claim 3, wherein the slide is self positioning.

11. A clamshell slide holder as recited in claim 1, wherein the base further comprises a channel for holding a slide.

12. A clamshell slide holder as recited in claim 11, wherein the channel is no wider than 100 millimeters.

13. A clamshell slide holder as recited in claim 1, wherein the slide comprises an array of biopolymers on at least one surface.

14. A clamshell slide holder as recited in claim 1, further comprising a hinge for rotatably mounting the lid to the base.

15. A method of mounting a slide in a slide holder, comprising:
(a) positioning a slide on at least one slide support with an raised reference surface to raise the slide off of the slide support;
(b) contacting the slide with a lid having at least one spring finger to self position the slide; and
(c) sliding the lid into a locked position to fix and retain the slide.

16. A method of mounting a slide in a clamshell slide holder, comprising:
(a) positioning a slide on at least one slide support with an raised reference surface to raise the slide off of the slide support;
(b) contacting the slide with a lid having at least one spring finger to position the slide; and
(c) sliding the lid into a locked position to fix and retain the slide.

17. A method of reading an array of moieties, comprising:
(a) mounting the slide in a clamshell slide holder; and
(b) inserting the clamshell slide holder into an array reader and reading the array.

18. A method according to claim 17, wherein the moieties are polynucleotides of different sequences.

19. A method according to claim 17, wherein the moieties are DNA of different sequences.

20. A method according to claim 17, wherein the array is read through the front side of the slide.

21. A method according to claim 17, wherein the array reading comprises directing a light beam through the slide from the front side and onto the array, and detecting a resulting signal from the array which has passed through the slide and out the slide front side.
